(19) United States
(12) Patent Application Publication
(10) Pub. No.: US 2025/0291267 A1
(43) Pub. Date: Sep. 18, 2025

(54) ELECTROPHOTOGRAPHIC DEVELOPER, ELECTROPHOTOGRAPHIC IMAGE FORMING METHOD, ELECTROPHOTOGRAPHIC IMAGE FORMING APPARATUS, AND PROCESS CARTRIDGE

(71) Applicants: Masashi NAGAYAMA, Kanagawa (JP); Tohru SUGANUMA, Kanagawa (JP); Hiroyuki KISHIDA, Kanagawa (JP)

(72) Inventors: Masashi NAGAYAMA, Kanagawa (JP); Tohru SUGANUMA, Kanagawa (JP); Hiroyuki KISHIDA, Kanagawa (JP)

(21) Appl. No.: 19/075,823

(22) Filed: Mar. 11, 2025

(30) Foreign Application Priority Data
Mar. 12, 2024 (JP) 2024-037862

(51) Int. Cl. G03G 9/08; G03G 9/087; G03G 9/09; G03G 9/107; G03G 15/01; G03G 15/08

(52) U.S. Cl. CPC G03G 9/081; G03G 9/08708; G03G 9/08755; G03G 9/08782; G03G 9/0904; G03G 9/108; G03G 15/0178; G03G 15/0805

(57) ABSTRACT

An electrophotographic developer is provided that includes a carrier and a pulverized toner. The carrier includes a core material particle and a coating layer coating the core material particle, and has an internal void ratio of 0.0% or more and less than 2.0%. The pulverized toner includes a polyester resin, an aromatic petroleum resin, and a hydrocarbon wax, and an addition amount of the aromatic petroleum resin is 2 parts by mass or more and 15 parts by mass or less with respect to 100 parts by mass of the pulverized toner.

### CROSS-REFERENCE TO RELATED APPLICATIONS

This patent application is based on and claims priority pursuant to 35 U.S.C. § 119 (a) to Japanese Patent Application No. 2024-037862, filed on Mar. 12, 2024, in the Japan Patent Office, the entire disclosure of which is hereby incorporated by reference herein.

### BACKGROUND

### Technical Field

The present disclosure relates to an electrophotographic developer, an electrophotographic image forming method, an electrophotographic image forming apparatus, and a process cartridge.

### Related Art

In general, in an image forming method such as an electrophotographic method or an electrostatic photographic method, a developer is used for developing an electrostatic latent image formed on a latent image bearer. The developer is required to be an appropriately charged mixture. In general, as a method for developing the electrostatic latent image, a two-component development system using a two-component developer obtained by mixing a toner and a carrier, and a one-component development system using a one-component developer containing no carrier are known.

The two-component development system is advantageous over the one-component development system in maintaining high image quality over an extended period of time because the carrier provides a wide area for frictionally charging the toner and has stable charging characteristics. In addition, the two-component development system has a capability of supplying the high amount of toner to a developing region, and thus is frequently employed particularly in a high-speed machine. Moreover, due to the above-described advantages, the two-component development system is widely employed in digital electrophotographic systems that visualize an electrostatic latent image formed on a photoconductor with a laser beam.

In attempting to enhance durability, carriers used in such a two-component development system are made to be coated with an appropriate resin material for the purpose of preventing toner spent on the carrier surface, forming a uniform carrier surface, preventing surface oxidation, preventing a decrease in moisture sensitivity, extending the life of the developer, protecting the photoconductor from scratches or abrasion by the carrier, controlling the charging polarity, or adjusting the charge amount.

### SUMMARY

Embodiments of the present invention provides an electrophotographic developer that includes a carrier and a pulverized toner. The carrier includes a core material particle and a coating layer coating the core material particle, and has an internal void ratio of 0.0% or more and less than 2.0%. The pulverized toner includes a polyester resin, an aromatic petroleum resin, and a hydrocarbon wax, and an addition amount of the aromatic petroleum resin is 2 parts by mass or more and 15 parts by mass or less with respect to 100 parts by mass of the pulverized toner.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an electrophotographic image forming apparatus according to an embodiment of the present invention; and

FIG. 2 is a schematic diagram illustrating a process cartridge according to an embodiment of the present invention.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

According to embodiments of the present invention, an electrophotographic developer is provided which can be fixed at a low temperature, which prevents toner spent on the carrier surface in long-term use to prevent a failure caused by a decrease in charging with time, and which also prevents shortening of the life of a photoconductor due to rubbing scratches to be described below, which is caused as a side effect of preventing the toner spent.

Embodiments of the present invention will be described in more detail below.

In recent years, low-temperature fixability of toner has been demanded in electrophotography. This is due not only to energy saving by reducing the energy required for fixing, but also to demands for higher speed and higher image quality of an electrophotographic image forming apparatus.

Various attempts have been made so far for improving fixability of toner. For example, there is known a method of controlling thermal properties of resins themselves represented by glass-transition temperature (Tg) and softening temperature (T1/2) in order to improve fixability of toner. In recent years, as described above, attempts have been made to use polyester resins, which have excellent low-temperature fixability and relatively high heat-resistant storage stability due to their high sharp melt properties, instead of styrene-acrylic resins, which have been frequently used in the past, in order to achieve low-temperature fixability.

When a toner component is spent on the carrier surface due to long-term use of a developer, the charging ability of the carrier decreases. When the charging ability of the carrier is lowered, the toner charge amount is lowered, and the toner is scattered from the developer to contaminate the surroundings, or the image density becomes unstable. Components of the toner spent on the carrier surface are, in many cases, an external additive, a binder resin, and a wax.

In particular, in a pulverized toner produced by a pulverization method in which raw materials such as a binder resin, a colorant, and a wax are melted and kneaded, and the kneaded product is cooled, and then pulverized and classified, the wax is generally more easily pulverized than the binder resin and is more easily exposed to the pulverization interface, and the wax is generally more softened at a low temperature than the binder resin, and thus the spent by the wax tends to be relatively easily generated. When the spent on the carrier surface becomes excessive, the charge imparting ability of the carrier is lowered, and the charging of the toner becomes insufficient. Therefore, the density of an output image becomes unstable, or the toner is scattered in the machine to cause contamination.

A resin-coated carrier is insulated by the resin coating and does not function as a developing electrode. Therefore, the resin-coated carrier is likely to cause an edge effect particularly in a solid image portion, which is unfavorable. In addition, since the counter charge becomes excessive at the time when the toner is detached, carrier adhesion to non-image portions is likely to occur due to electrostatic development. The carrier adhesion is a phenomenon in which the carrier moves (adheres) from the developer bearer to the photoconductor, and causes defects such as generation of white spots in an image and shortening of the life of the photoconductor due to scratches caused by the carrier adhering to the photoconductor being rubbed by the cleaning member together with the toner in the cleaning step in the apparatus. In particular, the rubbing scratches on the photoconductor are remarkable in a case where the fluidity of the toner is high and the cleaning member needs to be strongly pressed against the photoconductor in order to perform sufficient cleaning.

In order to solve this problem, for example, as described above, a resin-coated carrier in which conductive carbon or a conductive filler is dispersed as a conductive agent in the coating layer of the carrier has been proposed.

However, the surface-coated carrier tends to have a lower magnetization than the so-called core material particle before being coated. This is because the resin or conductive agent used as the coating material does not have magnetization. When the magnetization of the carrier becomes too low, the magnetic binding force from the developer bearer becomes weak, and thus the carrier cannot withstand the Coulomb force generated by the counter charge or the injection charging from the developer bearer and acting in a direction in which the carrier adhesion is generated, which also becomes a factor of the generation of the carrier adhesion.

The inventors of the present invention have conducted diligent studies to solve the above-described problems. As a result, an electrophotographic developer has been provided that includes a pulverized toner including a polyester resin, an aromatic petroleum resin, and a hydrocarbon wax, in which an addition amount of the aromatic petroleum resin is 2 parts by mass or more and 15 parts by mass or less with respect to 100 parts by mass of the pulverized toner, and a carrier having an internal void ratio of 0.0% or more and less than 2.0%. Thus, it has been found that such an electrophotographic developer can be fixed at a low temperature, prevents toner spent on the carrier surface in long-term use to prevent a failure caused by a decrease in charging with time, and also prevents shortening of the life of a photoconductor due to rubbing scratches to be described below, which is caused as a side effect of preventing the toner spent.

As described above, in order to enable the toner to be fixed at a low temperature, it is effective to use a polyester resin as the binder resin. However, even if a sharp-melt polyester resin is used, when a large number of output sheets immediately after fixing are continuously stacked in image output using a low-temperature fixing toner, a failure called paper discharge blocking occurs in which the sheets adhere to each other. It is effective to use a wax having a relatively high melting point in combination in order to prevent the paper discharge blocking, and as a result of repeated studies by the inventors of the present invention, it has been found that, among waxes having a relatively high melting point, particularly when a hydrocarbon wax is used, the effect of preventing the paper discharge blocking is high, and particularly when a Fischer-Tropsch wax is used, a high effect is obtained.

The toner according to an embodiment of the present invention is a pulverized toner produced by a pulverization method.

As described above, in the pulverized toner, since the wax is generally pulverized more easily than the binder resin, the wax is likely to be exposed at the pulverization interface, and since the wax having a relatively low softening point is directly brought into contact with the carrier surface, the spent by the wax is likely to occur. In particular, the hydrocarbon wax has a strong tendency to crack because the hydrocarbon wax is relatively fragile.

As a result, the inventors of the present invention have found that when an aromatic petroleum resin having excellent pulverizability is contained as a toner constituent, the aromatic petroleum resin portion is preferentially cracked in the toner pulverization step, and accordingly, the probability that the wax becomes the pulverization interface is reduced, and the exposure amount of the wax is reduced, and thus the spent of the wax on the carrier surface can be remarkably prevented.

Meanwhile, when the exposure amount of the wax decreases, the coefficient of friction between the particles decreases, and thus the fluidity of the toner tends to increase.

When the fluidity of the toner is high, the toner easily passes through a cleaning member in a photoconductor cleaning step in an electrophotographic developing process, and therefore, the cleaning member is preferably strongly pressed against the photoconductor. At this time, when the carrier particles are present on the photoconductor due to the above-described carrier adhesion, the carrier particles become a factor of damaging the photoconductor. As the cleaning member is strongly pressed against the photoconductor, the degree of damage to the photoconductor becomes significant, and the deterioration of the photoconductor is accelerated. The deterioration of the photoconductor due to the rubbing scratches causes defects such as an abnormal image such as a blurred image or a streak image, or a decrease in image density.

The inventors of the present invention have conducted intensive studies on this problem, and have found that when a carrier having a low internal void ratio is used as a developer, the amount of carrier particles mixed in the toner to be cleaned on the photoconductor in the cleaning step is reduced, and the deterioration rate of the photoconductor is reduced even when the above-described toner having high fluidity is used.

The toner according to an embodiment of the present invention is a pulverized toner produced by a pulverization method.

The pulverization method is a method for producing a toner by melting and kneading a binder resin, a colorant, a wax, and the like, which are toner components, cooling the kneaded product, and then pulverizing and classifying the cooled product. The toner according to an embodiment of the present invention contains a polyester resin.

### Polyester Resin

As the polyester resin, a polyester resin obtained by a polycondensation reaction between a generally known alcohol and a generally known carboxylic acid can be used.

Examples of the alcohol include, but are not limited to, diols, etherified bisphenols, divalent alcohol monomers obtained by substituting these alcohols with a saturated or unsaturated hydrocarbon group having 3 to 22 carbon atoms, and higher alcohol monomers having a valence of 3 or more.

Examples of the diols include, but are not limited to, ethylene glycol, polyethylene glycol, diethylene glycol, triethylene glycol, 1,2-propylene glycol, 1,3-propylene glycol, 1,4-propylene glycol, neopentyl glycol, and 1,4-butenediol.

Examples of the etherified bisphenols include, but are not limited to, 1,4-bis(hydroxymethyl) cyclohexane, bisphenol A, hydrogenated bisphenol A, polyoxyethylenated bisphenol A, polyoxypropylenated bisphenol A, bisphenol A propylene oxide, and bisphenol A ethylene oxide.

Examples of the higher alcohol monomers having a valence of 3 or more include, but are not limited to, sorbitol, 1,2,3,6-hexanetetrol, 1,4-sorbitan, pentaerythritol, dipentaerythritol, tripentaerythritol, sucrose, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

Each of these can be used alone or in combination with others.

Examples of the carboxylic acid include, but are not limited to, monocarboxylic acids, divalent organic acid monomers, anhydrides of these acids, dimers of lower alkyl esters with linolenic acid, and polyvalent carboxylic acid monomers having a valence of 3 or more.

Examples of the monocarboxylic acids include, but are not limited to, palmitic acid, stearic acid, and oleic acid.

Examples of the divalent organic acid monomers include, but are not limited to, maleic acid, fumaric acid, mesaconic acid, citraconic acid, terephthalic acid, cyclohexanedicarboxylic acid, succinic acid, adipic acid, sebacic acid, malonic acid, and these acids substituted with a saturated or unsaturated hydrocarbon group having 3 to 22 carbon atoms.

Examples of the polyvalent carboxylic acid monomers having a valence of 3 or more include, but are not limited to, 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, tetra(methylenecarboxyl)methane, 1,2,7,8-octanetetracarboxylic acid, enpol trimmer acid, and anhydrides of these acids.

Each of these can be used alone or in combination with others.

The molecular weight of the polyester resin is 3,500 or more and 5,500 or less, preferably 4,000 or more and 4,500 or less.

The molecular weight of the polyester resin can be determined from a molecular weight distribution of a tetrahydrofuran (THF) soluble matter obtained by gel permeation chromatography (GPC). A calibration curve can be prepared using standard polystyrene samples.

The content of the polyester resin is not particularly limited and may be appropriately selected depending on the purpose, and is preferably 70% by mass or more and 90% by mass or less, more preferably 75% by mass or more and 85% by mass or less, with respect to the toner.

The toner according to an embodiment of the present invention contains an aromatic petroleum resin.

### Aromatic Petroleum Resin

By containing the aromatic petroleum resin, the toner according to an embodiment of the present invention can have improved pulverizability and improved heat-resistant storage stability while maintaining low-temperature fixability.

The aromatic petroleum resin is a resin synthesized by using, as a raw material, styrene, vinyltoluene, indene, and the like, which are C9 fractions of petroleum. Known resins can be used, and examples thereof include, but are not limited to, styrene, α-methylstyrene, β-methylstyrene, vinyltoluene, indene, and copolymers thereof, such as styrene resins, α-methylstyrene resins, vinyltoluene resins, styrene-α-methylstyrene copolymers, and coumarone-indene resins. In particular, styrenic copolymers are preferable, and styrenic copolymers of α-methylstyrene are more preferable. A preferable example is a styrene-α-methylstyrene copolymer.

The weight average molecular weight (Mw) of the aromatic petroleum resin is preferably 2000 or more and 3500 or less. When the weight average molecular weight is 2000 or more, a high spent preventing effect can be secured. Further, when the weight average molecular weight is 3500 or less, good pulverizability can be secured.

The styrenic copolymer is not particularly limited. However, examples thereof include, but are not limited to, polymers of styrene and substituted products thereof such as polystyrene, poly-p-styrene, and polyvinyltoluene, and styrenic copolymers such as styrene-α-methylstyrene copolymer, styrene-p-chlorostyrene copolymer, styrene-propylene copolymer, styrene-vinyltoluene copolymer, styrene-methyl acrylate copolymer, styrene-ethyl acrylate copolymer, styrene-butyl acrylate copolymer, styrene-methyl methacrylate copolymer, styrene-ethyl methacrylate copolymer, styrene-butyl methacrylate copolymer, styrene-α-methyl chloromethacrylate copolymer, styrene-acrylonitrile copolymer, styrene-vinyl methyl ether copolymer, styrene-vinyl methyl ketone copolymer, styrene-butadiene copolymer, styrene-isoprene copolymer, styrene-maleic acid copolymer, and styrene-maleic acid ester copolymer. Among these copolymers, the styrene-α-methylstyrene copolymer is particularly preferable.

The glass-transition temperature (Tg) of the styrenic copolymer is preferably 60° C. or higher, and more preferably 65° C. or higher and 85° C. or lower. When the Tg of the styrenic copolymer is 60° C. or higher, the heat-resistant storage stability is also improved.

The Tg is measured using a differential scanning calorimeter (Q-200, manufactured by TA Instruments). Specifically, after putting about 5.0 mg of a target sample into an aluminum sample container, the sample container is placed on a holder unit and set in an electric furnace. Next, the temperature of the target sample is raised from −80° C. to 150° C. at a temperature rising rate of 10° C./min in a nitrogen atmosphere, and from the obtained differential scanning calorimetry (DSC) curve, the glass-transition temperature (Tg) of the target sample is obtained using an analysis program in the differential scanning calorimeter.

In the toner according to an embodiment of the present invention, the content of the aromatic petroleum resin is 2 parts by mass or more and 15 parts by mass or less with respect to 100 parts by mass of the toner. When the content is 2% by mass or more, the spent preventing effect can be improved in combination with the improvement in wax dispersibility while maintaining a certain level or more of pulverizability.

In addition, the aromatic petroleum resin is dispersed in the toner to improve pulverizability, but has a glass-transition temperature equal to or higher than a certain level, and thus acts in a direction of inhibiting low-temperature fixability. However, when the content is 15 parts by mass or less, the excellent low-temperature fixability of the polyester resin can be exhibited without being impaired.

The content of the aromatic petroleum resin in the toner is more preferably 3.5% by mass or more and 9.0% by mass or less.

The toner according to an embodiment of the present invention contains a hydrocarbon wax.

### Hydrocarbon Wax

The hydrocarbon wax has a relatively high melting point, and is suitable as a wax having a high effect of preventing paper discharge blocking. In particular, the hydrocarbon wax according to an embodiment of the present invention preferably has a melting point of 80° C. or higher and 100° C. or lower, and more preferably has a solubility parameter (SP) value of 8.0 (cal/cm³)^{1/2} or more and 8.5 (cal/cm³)^{1/2} or less.

When the melting point of the wax is equal to or higher than 80° C., not only the paper discharge blocking property can be improved, but also the thermal properties of the wax can be made close to those of the binder resins. As a result, these materials can be plasticized at the time of heating, and favorable low-temperature fixability can be secured. In addition, when the melting point of the wax is equal to or lower than 100° C., poor releasability due to insufficient melting of the wax during heating can be prevented, and favorable low-temperature fixability can be secured.

When the SP value of the wax is 8.0 (cal/cm³)^{1/2} or more, good dispersion of the aromatic petroleum resin can be maintained, and both pulverizability and low-temperature fixability can be achieved at a high level without causing fixing inhibition. In addition, when the SP value is 8.5 (cal/cm³)^{1/2} or less, compatibility with the aromatic petroleum resin can be prevented. As a result, a state in which a certain amount of the aromatic petroleum resin is dispersed in the toner can be achieved, and good pulverizability can be secured.

As the hydrocarbon wax, a known wax can be used. Examples of the wax include, but are not limited to, Fischer-Tropsch wax and microcrystalline wax, and Fischer-Tropsch wax is particularly preferable. Since the Fischer-Tropsch wax has a high melting point and a sharp molecular weight distribution, it is excellent in heat-resistant storage stability and spent resistance.

The addition amount of the wax in the toner is preferably 2.5% by mass or more and 6.5% by mass or less, and particularly preferably 3.5% by mass or more and 5.5% by mass or less. When the addition amount of the wax is 3.5% by mass or more and 5.5% by mass or less, it is possible to prevent deterioration in durability due to excessive wax while ensuring the releasability.

The melting point of the wax can be measured by the following means.

The glass-transition temperature and the melting point were measured under the following conditions by using a thermal analyzing workstation TA-60WS and a differential scanning calorimeter DSC-60 (manufactured by Shimadzu Corporation).
Sample container: Aluminum sample pan (with a lid)
Sample quantity: 5 mg
Reference: Aluminum sample pan (containing 10 mg of alumina)
Atmosphere: nitrogen (flow rate 50 ml/min)
Temperature rising/falling conditions
Start temperature: 20° C.
Temperature rising rate: 10° C./min
End temperature: 150° C.
Retention time: None
Temperature falling rate: 10° C./min
End temperature: 20° C.
Retention time: None
Temperature rising rate: 10° C./min
Retention time: None
(an endothermic peak observed in this rising temperature step is adopted as a melting point)
End temperature: 150° C.

### Other Toner Materials

The other toner material components are not particularly limited and may be appropriately selected depending on the purpose. Examples of the other toner material components include, but are not limited to, a colorant, resin fine particles, a charge control agent, an external additive, a fluidity improving agent, a cleanability improving agent, and a magnetic material.

### —Colorant—

As the colorant used in the toner according to an embodiment of the present invention, for example, dyes and pigments such as carbon black, lamp black, iron black, aniline blue, phthalocyanine blue, phthalocyanine green, Hansa Yellow G, Rhodamine 6C lake, Calco Oil Blue, chrome yellow, quinacridone, benzidine yellow, rose bengal, and triarylmethane dyes, and conventionally known dyes and pigments can be used.

These may be used alone or in combination, and may also be used as a black toner or a full-color toner.

The content of the colorant is preferably 1% by mass or more and 30% by mass or less, and more preferably 3% by mass or more and 20% mass or less, with respect to the binder resin component of the toner.

### —Charge Control Agent—

The charge control agent is not particularly limited and may be appropriately selected depending on the purpose. Examples of the charge control agent include, but are not limited to, nigrosine dyes, triphenylmethane dyes, chromium-containing metal complex dyes, chelate pigments of molybdic acid, Rhodamine dyes, alkoxyamines, quaternary ammonium salts (including fluorine-modified quaternary ammonium salts), alkylamides, phosphorus and phosphorus-containing compounds, tungsten and tungsten-containing compounds, fluorine activators, metal salts of salicylic acid, and metal salts of salicylic acid derivatives. Specific examples of the charge control agent include, but are not limited to, BONTRON® 03 (nigrosine dye), BONTRON® P-51 (quaternary ammonium salt), BONTRON® S-34 (metal-containing azo dye), BONTRON® E-82 (metal complex of oxynaphthoic acid), BONTRON® E-84 (metal complex of salicylic acid), and BONTRON® E-89 (phenolic condensation product), all manufactured by Orient Chemical Industries Co., Ltd.; TP-302 and TP-415 (molybdenum complexes of quaternary ammonium salts), and T-77 (azo iron compound), all manufactured by Hodogaya Chemical Co., Ltd.; LRA-901, and LR-147 (boron complex), manufactured by Japan Carlit Co., Ltd.; and cooper phthalocyanine, perylene, quinacridone, azo pigments, and other polymeric compounds having a functional group such as a sulfonic acid group, a carboxyl group, and a quaternary ammonium group.

### —External Additives—

The external additive is not particularly limited and may be appropriately selected depending on the purpose. Examples thereof include, but are not limited to, fatty acid metal salts such as zinc stearate and aluminum stearate, metal oxides such as titania, alumina, tin oxide, antimony oxide, and titanium oxide, silica, hydrophobic silica, and fluoropolymers. Among these, hydrophobic silica, titania, titanium oxide, and alumina are preferable.

The silica and the titanium oxide are preferably used as hydrophobic silica and hydrophobic titanium oxide by being subjected to a surface treatment with a fluidity improving agent to be described below.

Examples of the silica include, but are not limited to, R972, R974, RX200, RY200, R202, R805, and R812 (all manufactured by Nippon Aerosil Co., Ltd); and HDK-2000 (manufactured by Clariant K. K).

Examples of the titania include, but are not limited to, P-25 (manufactured by Nippon Aerosil Co., Ltd.); STT-30, STT-65C-S (manufactured by Titan Kogyo, Ltd.); TAF-140 (manufactured by Fuji Titanium Industry Co., Ltd.); and MT-150W, MT-500B, MT-600B, and MT-150A (all manufactured by Teika Corporation).

Examples of the titanium dioxide include, but are not limited to, T-805 (manufactured by Nippon Aerosil Co., Ltd.); STT-30A, STT-65S-S (both manufactured by Titan Kogyo, Ltd.); TAF-500T, TAF-1500T (both manufactured by Fuji Titanium Industry, Co., Ltd.); MT-100S, MT-100T (both manufactured by Teika Corporation); and IT-S (manufactured by Ishihara Sangyo Kisha, Ltd.).

### —Fluidity Improving Agent—

The fluidity improving agent is not particularly limited and can be appropriately selected depending on the purpose, as long as the fluidity improving agent provides increased hydrophobicity through surface treatment and allows prevention of deterioration in fluidity and charging characteristics even under high humidity. Examples of the fluidity improving agent include, but are not limited to, silane coupling agents, silylation agents, silane coupling agents having a fluorinated alkyl group, organic titanate coupling agents, aluminum coupling agents, silicone oils, and modified silicone oils.

The carrier according to an embodiment of the present invention has an internal void ratio of 0.0% or more and less than 2.0%.

In order to prevent the carrier adhesion, the magnetic binding force should be increased that each particle of the carrier receives from the developer bearer. The magnetic binding force acting on the carrier particles is proportional to the magnetic moment of each carrier particle. The magnetic moment of the carrier mostly depends on the magnetization of the core material particle (hereinafter, sometimes referred to as the “core material”). Since the magnetization per se is determined by the composition of the core material, in order to increase the magnetic moment per core material particle, it is effective to increase the mass of one core material particle as much as possible.

The carrier according to an embodiment of the present invention has an internal void ratio of 0.0% or more and less than 2.0%, and more preferably 0.3% or more and 1.9% or less. When the internal void ratio is 2.0% or more, the loss of the magnetic moment in one particle increases, and the carrier adhesion resistance decreases. From the viewpoint of carrier adhesion, the lower the internal void ratio, the more advantageous. However, when there is no internal void ratio, the apparent density of the carrier becomes too high, the volume occupied by the carrier with respect to the mass of the carrier becomes small, and it becomes difficult for charges to move between carriers in the developing region, and the leakage of counter charges may not catch up when the toner is developed.

In many cases, the internal void ratio of the carrier is substantially equal to the internal void ratio of the core material. This is because when the coating layer is formed by a generally used method such as a dipping method or a spraying method, voids are hardly formed in the coating layer. Therefore, the internal void ratio of the carrier can be adjusted by adjusting the internal void ratio of the core material. The internal void ratio of the core material can be adjusted by adjusting the composition and distribution of the raw materials, the firing temperature during the production of the core material, and the like.

The internal void ratio of the carrier can be measured as follows.

First, the carrier is cut, and the cross section is photographed. The cross section can be photographed by a conventionally known method such as scanning electron microscopy (SEM). Next, an area S of the outline of one particle is obtained from a cross-sectional photograph of the particle using conventionally known image analysis software (for example, ImageProPremier manufactured by MediaCybernetics, Inc). Similarly, an area s of void portions inside the one particle is acquired, and the void ratio of the one particle is calculated from the following formula.

$$Void ratio of one particle [ \% ] = ( s / S ) \times 100$$

This procedure is carried out for 60 randomly selected particles, and the average value is taken as the internal void ratio.

The apparent density of the carrier according to an embodiment of the present invention is preferably 2.4 g/cm³ or more and 2.7 g/cm³ or less. When the apparent density of the carrier exceeds 2.7 g/cm³, the space occupancy ratio occupied by the carrier particles present in the developing region during development from the development roller to the image carrier becomes low, and therefore the movement of charges via the carrier in the developing region becomes difficult, and an abnormal image such as a ghost is liable to occur. In addition, even if the internal void ratio is low in a state in which the apparent density is less than 2.4 g/cm³, it is not possible to obtain a sufficient magnetic moment, and the carrier adhesion deteriorates. The apparent density of the carrier can be adjusted by a known method, and is particularly useful as an adjustment factor because the composition and shape of the core material and the surface roughness greatly contribute to the adjustment.

The apparent density of carrier is measured according to JIS-Z2504: 2000.

The core material particle used for the carrier according to an embodiment of the present invention can be appropriately selected from the known core material particles for a two-component carrier for electrophotography depending on the purpose. In particular, Cu—Zn ferrite is suitable because the magnetic moment per carrier particle can be easily set in an appropriate range from the viewpoint of carrier adhesion resistance since the internal void ratio can be easily prevented to be relatively low.

The coating layer preferably contains conductive particles for the purpose of adjusting resistance. Known conductive particles can be used as the conductive particles, such as carbon black; tin oxides doped with tungsten, indium, phosphorus, or the like, or any of their oxides; and inorganic fine particles such as alumina and titania with tin oxide provided on the surface, where the tin oxide is doped with tungsten, indium, phosphorus, or the like, or any of their oxides. However, since many conductive particles are non-magnetic, if a large number of conductive particles are included to adjust the resistance, the magnetic moment of the carrier particles will be impaired. Therefore, conductive particles having a high resistance adjusting ability in a small amount are preferable, and carbon black is particularly preferable.

The coating layer may further contain a resin and other components as needed.

Examples of the resin used for the coating layer include, but are not limited to, silicone resins, acrylic resins, and combinations thereof. In the present disclosure, silicone resins refer to all known silicone resins. Examples thereof include, but are not limited to, straight silicone resins consisting of organosiloxane bonds, and modified silicone resins (e.g., alkyd-modified, polyester-modified, epoxy-modified, acrylic-modified, and urethane-modified silicone resins). Specific examples of commercially-available products of the straight silicone resins include, but are not limited to, KR271, KR255, and KR152 (manufactured by Shin-Etsu Chemical Co., Ltd.) and SR2400, SR2406, and SR2410 (manufactured by Dow Corning Toray Silicone Co., Ltd.). In this case, each of these silicone resins may be used alone or in combination with other components such as a cross-linking component and a charge amount controlling component. Specific examples of the modified silicone resins include, but are not limited to, KR206 (alkyd-modified), KR5208 (acrylic-modified), ES1001N (epoxy-modified), and KR305 (urethane-modified) manufactured by Shin-Etsu Chemical Co., Ltd.; and SR2115 (epoxy-modified) and SR2110 (alkyd-modified) manufactured by Dow Corning Toray Silicone Co., Ltd.

As the polycondensation catalyst, a known polycondensation catalyst can be used. Specific examples thereof include, but are not limited to, titanium catalysts, tin catalysts, zirconium catalysts, and aluminum catalysts.

The term “acrylic resin” as used herein refers to all resins having an acrylic component and is not particularly limited. In addition, the acrylic resin may be used alone or in combination with at least one other component capable of cross-linking reaction. Specific examples of the other cross-linking component include, but are not limited to, amino resins and acidic catalysts. Specific examples of the amino resins described herein include, but are not limited to, guanamine resins and melamine resins. Moreover, the acidic catalysts described herein refer to all materials having a catalytic action. Specific examples thereof include, but are not limited to, those having a reactive group such as a completely alkylated type, a methylol group type, an imino group type, and a methylol/imino group type.

The composition for forming the coating layer preferably contains a silane coupling agent. Thus, the conductive fine particles can be stably dispersed.

Specific examples of the silane coupling agent include, but are not limited to, γ-(2-aminoethyl) aminopropyl trimethoxysilane, γ-(2-aminoethyl) aminopropylmethyl dimethoxysilane, γ-methacryloxypropyl trimethoxysilane, N-β(N-vinylbenzylaminoethyl)-γ-aminopropyl trimethoxysilane hydrochloride, γ-glycidoxypropyl trimethoxysilane, γ-mercaptopropyl trimethoxysilane, methyl trimethoxysilane, methyl triethoxysilane, vinyl triacetoxysilane, γ-chloropropyl trimethoxysilane, hexamethyldisilazane, γ-anilinopropyl trimethoxysilane, vinyl trimethoxysilane, octadecyldimethyl[3-(trimethoxysilyl)propyl]ammonium chloride, γ-chloropropylmethyl dimethoxysilane, methyl trichlorosilane, dimethyl dichlorosilane, trimethyl chlorosilane, allyl triethoxysilane, 3-aminopropylmethyl diethoxysilane, 3-aminopropyl trimethoxysilane, dimethyl diethoxysilane, 1,3-divinyltetramethyl disilazane, and methacryloxyethyldimethyl(3-trimethoxysilylpropyl)ammonium chloride. Two or more of these materials can be used in combination.

Examples of commercially available silane coupling agents include, but are not limited to, AY43-059, SR6020, SZ6023, SH6026, SZ6032, SZ6050, AY43-310M, SZ6030, SH6040, AY43-026, AY43-031, sh6062, Z-6911, sz6300, sz6075, sz6079, sz6083, sz6070, sz6072, Z-6721, AY43-004, Z-6187, AY43-021, AY43-043, AY43-040, AY43-047, Z-6265, AY43-204M, AY43-048, Z-6403, AY43-206M, AY43-206E, Z6341, AY43-210MC, AY43-083, AY43-101, AY43-013, AY43-158E, Z-6920, Z-6940 (manufactured by Dow Corning Toray Silicone Co. Ltd.).

The addition amount of the silane coupling agent is preferably 0.1% by mass or more and 10% by mass or less with respect to the silicone resin. When the addition amount of the silane coupling agent is less than 0.1% by mass, the adhesion between the core material particles or the conductive fine particles and the silicone resin is reduced, and the coating layer may fall off during long-term use. When the addition amount of the silane coupling agent exceeds 10% by mass, toner filming may occur during long-term use.

The volume average particle diameter of the core material of the carrier is not particularly limited. For preventing the occurrence of carrier adhesion and carrier scattering, the volume average particle diameter is preferably 20 μm or more. For preventing the production of abnormal images, such as stripes made of carrier particles, and deterioration of image quality, the volume average particle diameter is preferably 100 μm or less. In particular, a core material having a volume average particle diameter of 20 μm or more and 70 μm or less can more preferably meet a recent demand for higher image quality. The volume average particle diameter can be measured using, for example, a particle size distribution analyzer MICROTRAC Model HRA9320-X100 (manufactured by Nikkiso Co., Ltd.).

The carrier according to an embodiment of the present invention may be manufactured by, for example, dissolving the resin or the like, in a solvent to prepare a coating solution and uniformly coating the surface of the core material particle with the coating solution by a known coating method, followed by drying and baking. Examples of the coating method include, but are not limited to, dipping, spraying, and brush coating.

The solvent is not particularly limited and can be appropriately selected depending on the purpose. Examples of the solvent include, but are not limited to, toluene, xylene, methyl ethyl ketone, methyl isobutyl ketone, cellosolve, and butyl acetate.

A method of the baking is not particularly limited and can be appropriately selected depending on the purpose, and may be, for example, external heating or internal heating.

A device for the baking is not particularly limited and can be appropriately selected depending on the purpose. Examples of the device include, but are not limited to, stationary electric furnaces, fluidized electric furnaces, rotary electric furnaces, burner furnaces, and devices including microwaves.

The average thickness of the coating layer is preferably 0.2 μm or greater and 1.2 μm or less, and more preferably 0.3 μm or greater and 1.0 μm or less.

Here, the average thickness of the coating layer can be measured by, for example, observing a cross section of the carrier with the use of a transmission electron microscope (TEM).

The electrophotographic image forming method according to an embodiment of the present invention forms an image with the use of the developer according to an embodiment of the present invention. The electrophotographic image forming apparatus according to an embodiment of the present invention includes the developer according to an embodiment of the present invention.

Specifically, the electrophotographic image forming method according to an embodiment of the present invention includes the steps of: forming an electrostatic latent image on an electrostatic latent image bearer (including charging the electrostatic latent image bearer and exposing the electrostatic latent image bearer to form the electrostatic latent image thereon); developing the electrostatic latent image formed on the electrostatic latent image bearer with the developer according to an embodiment of the present invention to form a toner image; transferring the toner image formed on the electrostatic latent image bearer onto a recording medium; and fixing the transferred toner image on the recording medium. The electrophotographic image forming method further includes other steps, as necessary.

Further, the electrophotographic image forming apparatus according to an embodiment of the present invention includes: an electrostatic latent image bearer; a charging device to charge the electrostatic latent image bearer; an exposing device to form an electrostatic latent image on the electrostatic latent image bearer; a developing device to develop the electrostatic latent image formed on the electrostatic latent image bearer with the developer according to an embodiment of the present invention to form a toner image; a transferring device to transfer the toner image formed on the electrostatic latent image bearer onto a recording medium; and a fixing device to fix the transferred toner image on the recording medium. The image forming apparatus may further include other devices such as a static elimination device, a cleaning device, a recycling device, and a control device, as necessary.

### (Electrophotographic Image Forming Apparatus)

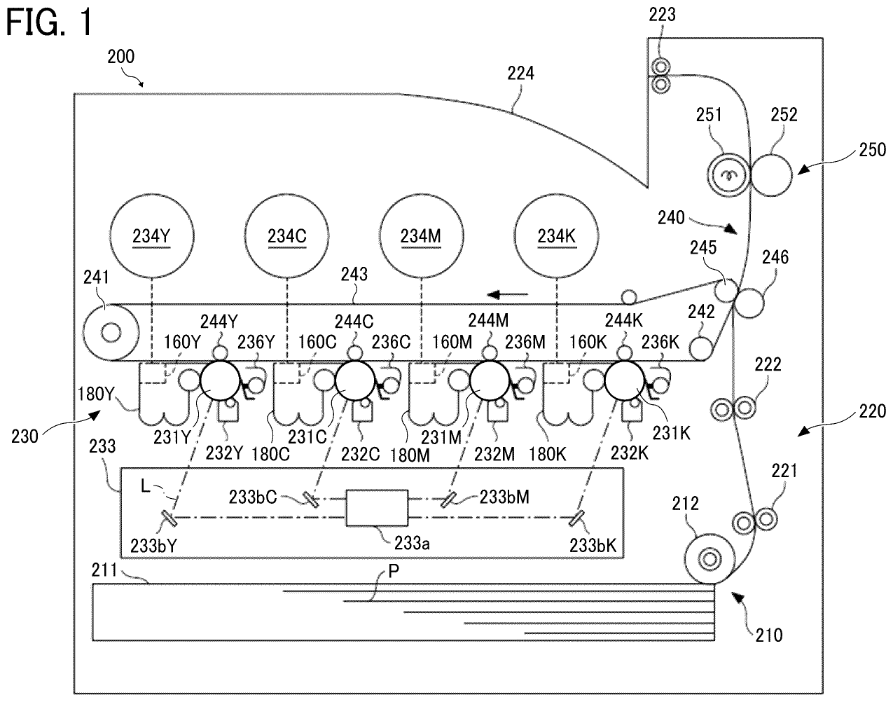

Next, a method for forming an image by an electrophotographic image forming apparatus according to an embodiment of the present invention will be described with reference to FIG. 1. As the electrophotographic image forming apparatus of the present embodiment, a printer is indicated as an example, but the electrophotographic image forming apparatus is not particularly limited as long as it is possible to form an image with the use of a toner of a copier, a facsimile, a multifunction peripheral, or the like.

An electrophotographic image forming apparatus 200 includes a paper feed unit 210, a conveyance unit 220, an image formation unit 230, a transfer unit 240, and a fixing device 250 including a fixing belt 251 and a pressure roller 252.

The paper feed unit 210 includes a paper feed cassette 211 in which paper sheets P are stacked, and a paper feed roller 212 that feeds the paper sheets P stacked in the paper feed cassette 211 one by one.

The conveyance unit 220 includes a roller 221 that conveys the paper sheet P fed by the paper feed roller 212 toward the transfer unit 240, a pair of timing rollers 222 that waits while sandwiching the leading edge of the paper sheet P conveyed by the roller 221 and feeds the paper to the transfer unit 240 at a predetermined timing, and a paper discharge roller 223 that discharges the paper sheet P with the color toner image fixed thereon to a paper discharge tray 224.

The image formation unit 230 includes, from left to right in FIG. 1 at predetermined intervals, an image forming unit 180Y that forms an image using a developer containing yellow toner, an image forming unit 180C that uses a developer containing cyan toner, an image forming unit 180M that uses a developer containing magenta toner, and an image forming unit 180K that uses a developer containing black toner, sub hoppers 160Y, 160C, 160M, and 160K, toner bottles 234Y, 234C, 234M, and 234K charging devices 232Y, 232C, 232M, and 232K, and exposure devices 233Y, 233C, 233M, and 233K. The exposure device 233 includes a light source 233a and polygon mirrors 233bY, 233bC, 233bM, and 233bK.

Any of the image forming units 180Y, 180C, 180M, and 180K is simply referred to as an image forming unit.

Further, the developer includes a toner and a carrier. The four image forming units 180Y, 180C, 180M, and 180K have substantially the same mechanical configuration except that the developers used therein are different from each other.

Here, as a developing procedure, a premix developing procedure may be adopted in which a premix developer is supplied, which is obtained by mixing a toner and a carrier in advance. In the premix developing procedure, the increased amount of carrier in the developing device is discharged as excess developer. Thus, the developer in the developing device is gradually refreshed. Therefore, it is possible to prolong the replacement cycle caused by deterioration of the developer, and to reduce the burden of replacing the developer.

The transfer unit 240 includes a driving roller 241 and a driven roller 242, an intermediate transfer belt 243 capable of rotating counterclockwise in FIG. 1 in accordance with the driving of the driving roller 241, primary transfer rollers 244Y, 244C, 244M, and 244K provided to face photoconductors 231Y, 231C, 231M, and 231K with the intermediate transfer belt 243 interposed therebetween, and a secondary counter roller 245 and a secondary transfer roller 246 provided to face each other with the intermediate transfer belt 243 interposed therebetween at a transfer position of a toner image to paper. Further, the image forming apparatus includes a cleaning devices 236Y, 236C, 236M, and 236K that removes transfer residual toner remaining on the surface of the photoconductors 231Y, 231C, 231M, and 231K.

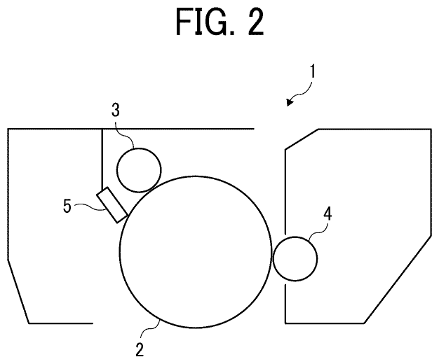

FIG. 2 is a schematic diagram illustrating a process cartridge according to an embodiment of the present invention. A process cartridge 1 integrally supports a photoconductor 2, a proximity type brush-like charging device 3, a developing device 4 accommodating the developer according to an embodiment of the present invention, and a cleaning device 5 having at least a cleaning blade, and is detachably mountable to the main body of an electrophotographic image forming apparatus. According to an embodiment of the present invention, the above-described components may be integrally combined as a process cartridge, and the process cartridge may be detachably mountable to the main body of an electrophotographic image forming apparatus such as a copier and a printer.

### EXAMPLE

Hereinafter, embodiments of the present invention will be described with reference to examples and comparative examples. It should be noted that the present invention is not limited to the examples illustrated herein. In the following descriptions, “parts” represent “parts by mass” and “%” represents “% by mass”.

### PREPARATION OF TONER

### Toner Production Example 1

### <Toner Base Particle 1>

Resin 1 (polyester resin) 75 parts
Resin 2 (α-methylstyrene resin) 7 parts
Wax (paraffin wax) 6 parts
Colorant (Carbon black) 11 parts
Charge control agent (azo iron compound) 1 part

According to the above-described preparation, toner raw materials were premixed by using a Henschel mixer (FM20B, manufactured by Mitsui Miike Kakoki Co., Ltd.), and then melted and kneaded at a temperature of 120° C. by a twin-screw kneader (PCM-30, manufactured by Ikegai Iron Works Co., Ltd.).

The obtained kneaded product was rolled to a thickness of 2.7 mm by a roller, and then, cooled to room temperature by a belt cooler and coarsely ground to a size of 200 μm to 300 μm by a hammer mill.

Subsequently, the obtained product was finely pulverized by using a supersonic jet pulverizer Labojet (manufactured by Nippon Pneumatic Mfg. Co., Ltd.). Afterwards, an air classifier (MDS-I, manufactured by Nippon Pneumatic Mfg. Co., Ltd.) was used to classify the particles while appropriately adjusting the louver opening so that the mass average particle diameter was 5.8±0.2 μm, to obtain the [Toner Base Particle 1].

### <External Addition Treatment>

[Toner 1] was produced by adding 1 part of hydrophobic silica as an external additive to 100 parts of the [Toner Base Particle 1], followed by stirring and mixing with a Henschel mixer to subject the [Toner Base Particle 1] to external addition treatment. The content of the resin 2 in 100 parts of [Toner 1] is 7 parts.

### Toner Production Example 2

[Toner 2] was obtained in the same manner as in Toner Production Example 1 except that the resin 2 was changed to a coumarone-indene resin.

### Toner Production Example 3

[Toner 3] was obtained in the same manner as in Toner Production Example 1 except that the resin 2 was changed to a vinyltoluene resin.

### Toner Production Example 4

[Toner 4] was obtained in the same manner as in Toner Production Example 1 except that the resin 1 was changed to a styrene acrylic resin.

### Toner Production Example 5

[Toner 5] was obtained in the same manner as in Toner Production Example 1 except that the amount of the resin 2 was changed to 15 parts (14 parts with respect to 100 parts of the toner).

### Toner Production Example 6

[Toner 6] was obtained in the same manner as in Toner Production Example 1 except that the amount of the resin 2 was changed to 18 parts (16 parts with respect to 100 parts of the toner).

### Toner Production Example 7

[Toner 7] was obtained in the same manner as in Toner Production Example 1 except that the amount of the resin 2 was changed to 3 parts (3 parts with respect to 100 parts of the toner).

### Toner Production Example 8

[Toner 8] was obtained in the same manner as in Toner Production Example 1 except that the amount of the resin 2 was changed to 1 part (1 part with respect to 100 parts of the toner).

### Toner Production Example 9

[Toner 9] was obtained in the same manner as in Toner Production Example 1 except that the polymer 2 was changed to an isoprene resin (C5 petroleum resin).

### Toner Production Example 10

[Toner 10] was obtained in the same manner as in Toner Production Example 1 except that the wax was changed to carnauba wax (natural wax).

### Toner Production Example 11

[Toner 11] was obtained in the same manner as in Toner Production Example 1 except that the wax was changed to Fischer-Tropsch wax.

### Toner Production Example 12

[Toner 12] was obtained in the same manner as in Toner Production Example 11 except that the resin 2 was changed to a styrene-α-methylstyrene copolymer. The composition of the obtained toner is indicated in Table 1.

In Table 1, the numerical value of “the number of parts of the resin 2 with respect to 100 parts of the toner” indicates the number of parts of the resin 2 in 100 parts of the toner.

TABLE 1

| | | | PARTS OF RESIN 2 | |
|---|---|---|---|---|
| | | | WITH RESPECT TO | |
| | | | 100 PARTS OF | |
| | RESIN 1 | RESIN 2 | TONER [PART] | WAX |
| TONER 1 | POLYESTER RESIN | α-METHYLSTYRENE RESIN | 7 | PARAFFIN WAX |
| TONER 2 | POLYESTER RESIN | COUMARONE-INDENE RESIN | 7 | PARAFFIN WAX |
| TONER 3 | POLYESTER RESIN | VINYLTOLUENE RESIN | 7 | PARAFFIN WAX |
| TONER 4 | STYRENE ACRYLIC RESIN | α-METHYLSTYRENE RESIN | 7 | PARAFFIN WAX |
| TONER 5 | POLYESTER RESIN | α-METHYLSTYRENE RESIN | 14 | PARAFFIN WAX |
| TONER 6 | POLYESTER RESIN | α-METHYLSTYRENE RESIN | 16 | PARAFFIN WAX |
| TONER 7 | POLYESTER RESIN | α-METHYLSTYRENE RESIN | 3 | PARAFFIN WAX |
| TONER 8 | POLYESTER RESIN | α-METHYLSTYRENE RESIN | 1 | PARAFFIN WAX |
| TONER 9 | POLYESTER RESIN | ISOPRENE RESIN | 7 | PARAFFIN WAX |
| TONER 10 | POLYESTER RESIN | α-METHYLSTYRENE RESIN | 7 | CARNAUBA WAX |
| TONER 11 | POLYESTER RESIN | α-METHYLSTYRENE RESIN | 7 | FISCHER-TROPSCH WAX |
| TONER 12 | POLYESTER RESIN | STYRENE-α-METHYLSTYRENE | 7 | FISCHER-TROPSCH WAX |
| | | COPOLYMER | | |

### PREPARATION OF CARRIER

### Carrier Production Example 1

### <Core Material 1>

Mn ferrite

Internal void ratio: 1.0%, apparent density: 2.2 g/cm³

### <Resin Liquid 1>

Silicone resin solution (solid content: 40%) 2000 parts
Amino silane (solid content concentration: 100%) 30 parts
Tungsten oxide-doped tin oxide coated alumina 1200 parts
Toluene 6000 parts

Each material of the resin liquid 1 was dispersed for 10 minutes by a HOMOMIXER to prepare a coating layer forming liquid.

The coating layer forming liquid of the resin liquid 1 was applied to the core material 1 at a rate of 30 g/min in an atmosphere of 55° C. by SPIRA COTA (manufactured by Okada Seiko Co., Ltd.) and dried in such a manner that the thickness of the coating layer on the surface of the core material 1 was 0.8 μm. The thickness of the resulting layer was adjusted by adjusting the amount of the resin liquid. The resulted carrier was burnt in an electric furnace at 150° C. for 1 hour, then cooled, and pulverized with a sieve having an opening of 100 μm. Thus, a [Carrier 1] was obtained.

### Carrier Production Example 2

[Carrier 2] was obtained in the same manner as in Carrier Production Example 1 except that the core material 1 was changed to the following core material 2.

### <Core Material 2>

Mn ferrite

Internal void ratio: 1.9%, apparent density: 2.2 g/cm³

### Carrier Production Example 3

[Carrier 3] was obtained in the same manner as in Carrier Production Example 1 except that the core material 1 was changed to the following core material 3.

### <Core Material 3>

Mn ferrite

Internal void ratio: 2.2%, apparent density: 2.1 g/cm³

### Carrier Production Example 4

[Carrier 4] was obtained in the same manner as in Carrier Production Example 1 except that the core material 1 was changed to the following core material 4.

### <Core Material 4>

Mn ferrite

Internal void ratio: 0.1%, apparent density: 2.3 g/cm³

### Carrier Production Example 5

[Carrier 5] was obtained in the same manner as in Carrier Production Example 1 except that the core material 1 was changed to the following core material 5.

### <Core Material 5>

Mn ferrite

Internal void ratio: 1.8%, apparent density: 2.4 g/cm³

### Carrier Production Example 6

[Carrier 6] was obtained in the same manner as in Carrier Production Example 1 except that the core material 1 was changed to the following core material 6.

### <Core Material 6>

Mn ferrite

Internal void ratio: 1.2%, apparent density: 2.6 g/cm³

### Carrier Production Example 7

[Carrier 7] was obtained in the same manner as in Carrier Production Example 1 except that the core material 1 was changed to the following core material 7.

### <Core Material 7>

Mn ferrite

Internal void ratio: 0.9%, apparent density: 2.7 g/cm³

### Carrier Production Example 8

[Carrier 8] was obtained in the same manner as in Carrier Production Example 1 except that the core material 1 was changed to the following core material 8.

### <Core Material 8>

Mn ferrite

Internal void ratio: 0.5%, apparent density: 2.9 g/cm³

### Carrier Production Example 9

[Carrier 9] was obtained in the same manner as in Carrier Production Example 6 except that the resin liquid 1 was changed to the following resin liquid 2.

### <Resin Liquid 2>

Silicone resin solution (solid content: 40%) 2000 parts
Amino silane (solid content concentration: 100%) 30 parts
Carbon black 300 parts
Toluene 6000 parts

### Carrier Production Example 10

[Carrier 10] was obtained in the same manner as in Carrier Production Example 9 except that the core material 6 was changed to the following core material 9.

### <Core Material 9>

Cu-Zn ferrite

Internal void ratio: 0.6%, apparent density: 2.7 g/cm³

The internal void ratio and the apparent density of the core material and the carrier of each of the obtained carriers are indicated in Table 2.

TABLE 2

| | CARRIER | | | CORE MATERIAL | | | |
|---|---|---|---|---|---|---|---|
| | INTERNAL | | | | | INTERNAL | |
| | VOID | APPARENT | RESISTANCE | CORE | CORE | VOID | APPARENT |
| | RATIO | DENSITY | ADJUSTING | MATERIAL | MATERIAL | RATIO | DENSITY |
| | [%] | [g/cm³] | AGENT | No. | COMPOSITION | [%] | [g/cm³] |
| CARRIER 1 | 1.0 | 2.1 | WTO COATED | CORE | Mn FERRITE | 1.0 | 2.2 |
| | | | ALUMINA | MATERIAL 1 | | | |
| CARRIER 2 | 1.9 | 2.1 | WTO COATED | CORE | Mn FERRITE | 1.9 | 2.2 |
| | | | ALUMINA | MATERIAL 2 | | | |
| CARRIER 3 | 2.2 | 2.0 | WTO COATED | CORE | Mn FERRITE | 2.2 | 2.1 |
| | | | ALUMINA | MATERIAL 3 | | | |
| CARRIER 4 | 0.1 | 2.2 | WTO COATED | CORE | Mn FERRITE | 0.1 | 2.3 |
| | | | ALUMINA | MATERIAL 4 | | | |
| CARRIER 5 | 1.8 | 2.3 | WTO COATED | CORE | Mn FERRITE | 1.8 | 2.4 |
| | | | ALUMINA | MATERIAL 5 | | | |
| CARRIER 6 | 1.2 | 2.5 | WTO COATED | CORE | Mn FERRITE | 1.2 | 2.6 |
| | | | ALUMINA | MATERIAL 6 | | | |
| CARRIER 7 | 0.9 | 2.6 | WTO COATED | CORE | Mn FERRITE | 0.9 | 2.7 |
| | | | ALUMINA | MATERIAL 7 | | | |
| CARRIER 8 | 0.5 | 2.8 | WTO COATED | CORE | Mn FERRITE | 0.5 | 2.9 |
| | | | ALUMINA | MATERIAL 8 | | | |
| CARRIER 9 | 1.2 | 2.5 | CARBON | CORE | Mn FERRITE | 1.2 | 2.6 |
| | | | BLACK | MATERIAL 6 | | | |
| CARRIER 10 | 0.6 | 2.6 | CARBON | CORE | Cu—Zn FERRITE | 0.6 | 2.7 |
| | | | BLACK | MATERIAL 9 | | | |

### EXAMPLE 1

[Developer 1] was produced by mixing 5 parts of [Toner 1] obtained in Toner Production Example and 95 parts of [Carrier 1] obtained in Carrier Production Example 1 with a mixer for 10 minutes.

The developer was set in a digital full-color printer (MP6503, manufactured by Ricoh Co., Ltd.) which was modified in such a manner that the fixing temperature could be changed and in which the pressing strength of the cleaning member was adjusted so that cleaning could be performed without any problem, and evaluation with the initial developer was performed. Further, 100,000 images of a character chart having an image area of 10% were output at a default fixing temperature specification, and the developer (aging agent) was evaluated.

### Low-temperature Fixability

Before outputting an image on 100,000 sheets, a solid image having an adhesion amount of 0.4 mg/cm² was sequentially outputted on paper (Type6200, manufactured by Ricoh Co., Ltd.) in increments of a fixing temperature of 5° C. through exposing, developing, and transferring steps, and the occurrence of cold offset was visually determined to measure the lower limit fixing temperature. The lower limit fixing temperature was evaluated on the basis of the following evaluation criteria.

### (Evaluation Criteria)

A: Lower than 130° C.
B: 130° C. or higher and lower than 140° C.
C: 140° C. or higher and lower than 150° C.
D: 150° C. or higher

### Charge Decrease Amount

The charge decrease amount was evaluated before and after the image output of 100,000 sheets.

First, a sample (initial developer) obtained by mixing 95% of an initial carrier and 5% by mass of a toner and frictionally charging the mixture is measured by a general blow-off method (TB-200, manufactured by Toshiba Chemical Corporation), and this measured amount is defined as an initial charge amount. Next, the toner is removed from the developer after the image output by the blow-off device, a new toner is mixed at a ratio of 5% with respect to 95% of the obtained carrier, and a sample which is frictionally charged in the same manner as the initial carrier is subjected to the charge amount measurement in the same manner as the initial carrier, and a difference from the initial charge amount is set as the charge decrease amount. The target value of the charge decrease width is less than 10.0 μC/g. The charge decrease amount was evaluated on the basis of the following evaluation criteria.

### (Evaluation Criteria)

A: Less than 4.0 μC/g
B: 4.0 μC/g or more and less than 6.0 μC/g
C: 6.0 μC/g or more and less than 8.0 μC/g
D: 8.0 μC/g or more and less than 10.0 μC/g
E: 10.0 μC/g or more

### Images Over Time

The images after the output of 100,000 sheets were visually observed, and the images over time were evaluated on the basis of the following evaluation criteria based on blurring of the image, a streak image, and a decrease in image density.

### (Evaluation Criteria)

A+: Very good
A: Good
B: Acceptable
C: Practically unacceptable level

### Paper Discharge Blocking

A 3 cm×15 cm rectangular solid image was formed on PPC paper type 6000 <70W>A4 T (manufactured by Ricoh Co., Ltd.) in such a manner that the toner adhesion amount was 0.85 mg/cm², and 500 sheets were continuously printed on one side. The fixing temperature was controlled so as to be centered on the cold offset temperature +20° C. The 500 output images were stacked and left for 1 hour, and then adhesion between the images was evaluated on the basis of the following evaluation criteria.

### (Evaluation Criteria)

A: The sheets are not sticking to each other.
B: Although the sheets are slightly stuck to each other, they are easily peeled off, and there is no problem in the peeled image.
C: The sheets are slightly stuck to each other, and sound is slightly generated when the sheets are peeled off, but there is no problem in the peeled image.
D: The sheets are stuck to each other, and the image or paper is damaged when peeled off.

### Heat-Resistant Storage Stability

The toner 10 g used in the developer of each example was placed in a 30 ml screw vial, tapped 100 times with a tapping machine, stored in a thermostatic bath in a 50° C. environment for 24 hours, returned to room temperature, and then the penetration was measured with a penetration tester, and the heat-resistant storage stability was evaluated on the basis of the following evaluation criteria.

### (Evaluation Criteria)

A: Penetrated
B: 20 mm or more
C: 15 mm or more and less than 20 mm
D: 10 mm or more and less than 15 mm
E: Less than 10 mm

### Ghost

A solid image was output with the initial developer, and the difference between the image density at the leading end of the image and the image density after one rotation of the development roller was visually observed to evaluate the ghost on the basis of the following evaluation criteria.
A+: Very good
A: Good
B: Acceptable
C: Practically unacceptable level

### Examples 2 to 15 and Comparative Examples 1 to 6

[Toner 1] to [Toner 12] and [Carrier 1] to [Carrier 10] were used in the same manner as in Example 1 except that Developers 2 to 21 were prepared using the combinations indicated in Table 3, and the evaluation was conducted.

The properties of the toners and carriers in Developers 1 to 21 are indicated in Table 3, and the evaluation results of Developers 1 to 21 are indicated in Table 4.

TABLE 3

| | | TONER | | | | |
|---|---|---|---|---|---|---|
| | | | | | PARTS OF | |
| | | | | | RESIN 2 WITH | |
| EXAMPLE | | | | | RESPECT TO | |
| COMPARATIVE | DEVELOPER | | | | 100 PARTS OF | |
| EXAMPLE No. | No. | | RESIN 1 | RESIN 2 | TONER [PART] | WAX |
| EXAMPLE 1 | DEVELOPER 1 | TONER 1 | POLYESTER | α- | 7 | PARAFFIN |
| | | | RESIN | METHYLSTYRENE | | WAX |
| | | | | RESIN | | |
| EXAMPLE 2 | DEVELOPER 2 | TONER 2 | POLYESTER | COUMARONE- | 7 | PARAFFIN |
| | | | RESIN | INDENE | | WAX |
| | | | | RESIN | | |
| EXAMPLE 3 | DEVELOPER 3 | TONER 3 | POLYESTER | VINYLTOLUENE | 7 | PARAFFIN |
| | | | RESIN | RESIN | | WAX |
| COMP. | DEVELOPER 4 | TONER 4 | STYRENE | α- | 7 | PARAFFIN |
| EXAMPLE 1 | | | ACRYLIC | METHYLSTYRENE | | WAX |
| | | | RESIN | RESIN | | |
| EXAMPLE 4 | DEVELOPER 5 | TONER 5 | POLYESTER | α- | 14 | PARAFFIN |
| | | | RESIN | METHYLSTYRENE | | WAX |
| | | | | RESIN | | |
| COMP. | DEVELOPER 6 | TONER 6 | POLYESTER | α- | 16 | PARAFFIN |
| EXAMPLE 2 | | | RESIN | METHYLSTYRENE | | WAX |
| | | | | RESIN | | |
| EXAMPLE5 | DEVELOPER 7 | TONER 7 | POLYESTER | α- | 3 | PARAFFIN |
| | | | RESIN | METHYLSTYRENE | | WAX |
| | | | | RESIN | | |
| COMP. | DEVELOPER 8 | TONER 8 | POLYESTER | α- | 1 | PARAFFIN |
| EXAMPLE 3 | | | RESIN | METHYLSTYRENE | | WAX |
| | | | | RESIN | | |
| COMP. | DEVELOPER 9 | TONER 9 | POLYESTER | ISOPRENE | 7 | PARAFFIN |
| EXAMPLE 4 | | | RESIN | RESIN | | WAX |
| COMP. | DEVELOPER 10 | TONER 10 | POLYESTER | α- | 7 | CARNAUBA |
| EXAMPLE 5 | | | RESIN | METHYLSTYRENE | | WAX |
| | | | | RESIN | | |
| EXAMPLE 6 | DEVELOPER 11 | TONER 1 | POLYESTER | α- | 7 | PARAFFIN |
| | | | RESIN | METHYLSTYRENE | | WAX |
| | | | | RESIN | | |
| COMP. | DEVELOPER 12 | TONER 1 | POLYESTER | α- | 7 | PARAFFIN |
| EXAMPLE 5 | | | RESIN | METHYLSTYRENE | | WAX |
| | | | | RESIN | | |
| EXAMPLE 7 | DEVELOPER 13 | TONER 1 | POLYESTER | α- | 7 | PARAFFIN |
| | | | RESIN | METHYLSTYRENE | | WAX |
| | | | | RESIN | | |
| EXAMPLE 8 | DEVELOPER 14 | TONER 11 | POLYESTER | α- | 7 | FISCHER- |
| | | | RESIN | METHYLSTYRENE | | TROPSCH |
| | | | | RESIN | | WAX |
| EXAMPLE 9 | DEVELOPER 15 | TONER 11 | POLYESTER | α- | 7 | FISCHER- |
| | | | RESIN | METHYLSTYRENE | | TROPSCH |
| | | | | RESIN | | WAX |
| EXAMPLE 10 | DEVELOPER 16 | TONER 11 | POLYESTER | α- | 7 | FISCHER- |
| | | | RESIN | METHYLSTYRENE | | TROPSCH |
| | | | | RESIN | | WAX |
| EXAMPLE 11 | DEVELOPER 17 | TONER 11 | POLYESTER | α- | 7 | FISCHER- |
| | | | RESIN | METHYLSTYRENE | | TROPSCH |
| | | | | RESIN | | WAX |
| EXAMPLE 12 | DEVELOPER 18 | TONER 11 | POLYESTER | α- | 7 | FISCHER- |
| | | | RESIN | METHYLSTYRENE | | TROPSCH |
| | | | | RESIN | | WAX |
| EXAMPLE 13 | DEVELOPER 19 | TONER 11 | POLYESTER | α- | 7 | FISCHER- |
| | | | RESIN | METHYLSTYRENE | | TROPSCH |
| | | | | RESIN | | WAX |
| EXAMPLE 14 | DEVELOPER 20 | TONER 11 | POLYESTER | α- | 7 | FISCHER- |
| | | | RESIN | METHYLSTYRENE | | TROPSCH |
| | | | | RESIN | | WAX |
| EXAMPLE 15 | DEVELOPER 21 | TONER 12 | POLYESTER | STYRENE-α- | 7 | FISCHER- |
| | | | RESIN | METHYLSTYRENE | | TROPSCH |
| | | | | COPOLYMER | | WAX |

| | CARRIER | | | | |
|---|---|---|---|---|---|
| | | INTERNAL | | | |
| EXAMPLE | | VOID | APPARENT | RESISTANCE | |
| COMPARATIVE | | RATIO | DENSITY | ADJUSTING | CORE |
| EXAMPLE No. | | [%] | [g/cm³] | AGENT | MATERIAL |
| EXAMPLE 1 | CARRIER 1 | 1.0 | 2.1 | WTO | Mn |
| | | | | COATED | FERRITE |
| | | | | ALUMINA | |
| EXAMPLE 2 | CARRIER 1 | 1.0 | 2.1 | WTO | Mn |
| | | | | COATED | FERRITE |
| | | | | ALUMINA | |
| EXAMPLE 3 | CARRIER 1 | 1.0 | 2.1 | WTO | Mn |
| | | | | COATED | FERRITE |
| | | | | ALUMINA | |
| COMP. | CARRIER 1 | 1.0 | 2.1 | WTO | Mn |
| EXAMPLE 1 | | | | COATED | FERRITE |
| | | | | ALUMINA | |
| EXAMPLE 4 | CARRIER 1 | 1.0 | 2.1 | WTO | Mn |
| | | | | COATED | FERRITE |
| | | | | ALUMINA | |
| COMP. | CARRIER 1 | 1.0 | 2.1 | WTO | Mn |
| EXAMPLE 2 | | | | COATED | FERRITE |
| | | | | ALUMINA | |
| EXAMPLE5 | CARRIER 1 | 1.0 | 2.1 | WTO | Mn |
| | | | | COATED | FERRITE |
| | | | | ALUMINA | |
| COMP. | CARRIER 1 | 1.0 | 2.1 | WTO | Mn |
| EXAMPLE 3 | | | | COATED | FERRITE |
| | | | | ALUMINA | |
| COMP. | CARRIER I | 1.0 | 2.1 | WTO | Mn |
| EXAMPLE 4 | | | | COATED | FERRITE |
| | | | | ALUMINA | |
| COMP. | CARRIER 1 | 1.0 | 2.1 | WTO | Mn |
| EXAMPLE 5 | | | | COATED | FERRITE |
| | | | | ALUMINA | |
| EXAMPLE 6 | CARRIER 2 | 1.9 | 2.1 | WTO | Mn |
| | | | | COATED | FERRITE |
| | | | | ALUMINA | |
| COMP. | CARRIER 3 | 2.2 | 2.0 | WTO | Mn |
| EXAMPLE 5 | | | | COATED | FERRITE |
| | | | | ALUMINA | |
| EXAMPLE 7 | CARRIER 4 | 0.1 | 2.2 | WTO | Mn |
| | | | | COATED | FERRITE |
| | | | | ALUMINA | |
| EXAMPLE 8 | CARRIER 1 | 1.0 | 2.1 | WTO | Mn |
| | | | | COATED | FERRITE |
| | | | | ALUMINA | |
| EXAMPLE 9 | CARRIER 5 | 1.8 | 2.3 | WTO | Mn |
| | | | | COATED | FERRITE |
| | | | | ALUMINA | |
| EXAMPLE 10 | CARRIER 6 | 1.2 | 2.5 | WTO | Mn |
| | | | | COATED | FERRITE |
| | | | | ALUMINA | |
| EXAMPLE 11 | CARRIER 7 | 0.9 | 2.6 | WTO | Mn |
| | | | | COATED | FERRITE |
| | | | | ALUMINA | |
| EXAMPLE 12 | CARRIER 8 | 0.5 | 2.8 | WTO | Mn |
| | | | | COATED | FERRITE |
| | | | | ALUMINA | |
| EXAMPLE 13 | CARRIER 9 | 1.2 | 2.5 | CARBON | Mn |
| | | | | BLACK | FERRITE |
| EXAMPLE 14 | CARRIER 10 | 0.6 | 2.6 | CARBON | Cu—Zn |
| | | | | BLACK | FERRITE |
| EXAMPLE 15 | CARRIER 10 | 0.6 | 2.6 | CARBON | Cu—Zn |
| | | | | BLACK | FERRITE |

TABLE 4

| | | | | LOW- | | | | | |
|---|---|---|---|---|---|---|---|---|---|
| | | | | TEMPER- | CHARGE | | | HEAT- | |
| EXAMPLE | | | | ATURE | DECREASE | IMAGES | PAPER | RESISTANT | |
| COMPARATIVE | DEVELOPER | | | FIX- | AMOUNT | OVER | DISCHARGE | STORAGE | |
| EXAMPLE No. | No. | TONER | CARRIER | ABILITY | [μC/g] | TIME | BLOCKING | STABILITY | GHOST |
| EXAMPLE 1 | DEVELOPER 1 | TONER 1 | CARRIER 1 | B | C | A | B | C | A+ |
| EXAMPLE 2 | DEVELOPER 2 | TONER 2 | CARRIER 1 | C | C | A | B | C | A+ |
| EXAMPLE 3 | DEVELOPER 3 | TONER 3 | CARRIER 1 | C | C | A | B | C | A+ |
| COMP. | DEVELOPER 4 | TONER 4 | CARRIER 1 | D | C | A | A | C | A+ |
| EXAMPLE 1 | | | | | | | | | |
| EXAMPLE 4 | DEVELOPER 5 | TONER 5 | CARRIER 1 | C | A | A | B | A | A+ |
| COMP. | DEVELOPER 6 | TONER 6 | CARRIER 1 | D | A | A | A | A | A+ |
| EXAMPLE 2 | | | | | | | | | |
| EXAMPLE 5 | DEVELOPER 7 | TONER 7 | CARRIER 1 | A | D | A | C | D | A+ |
| COMP. | DEVELOPER 8 | TONER 8 | CARRIER 1 | A | E | A | C | D | A+ |
| EXAMPLE 3 | | | | | | | | | |
| COMP. | DEVELOPER 9 | TONER 9 | CARRIER 1 | D | E | A | C | E | A+ |
| EXAMPLE 4 | | | | | | | | | |
| COMP. | DEVELOPER 10 | TONER 10 | CARRIER 1 | A | D | A | D | C | A+ |
| EXAMPLE 5 | | | | | | | | | |
| EXAMPLE 6 | DEVELOPER 11 | TONER 1 | CARRIER 2 | B | C | B | B | C | A+ |
| COMP. | DEVELOPER 12 | TONER 1 | CARRIER 3 | B | C | C | B | C | A+ |
| EXAMPLE 6 | | | | | | | | | |
| EXAMPLE 7 | DEVELOPER 13 | TONER 1 | CARRIER 4 | B | C | A+ | B | C | A+ |
| EXAMPLE 8 | DEVELOPER 14 | TONER 11 | CARRIER 1 | B | B | A | A | B | A+ |
| EXAMPLE 9 | DEVELOPER 15 | TONER 11 | CARRIER 5 | B | B | A | A | B | A+ |
| EXAMPLE 10 | DEVELOPER 16 | TONER 11 | CARRIER 6 | B | B | A | A | B | A |
| EXAMPLE 11 | DEVELOPER 17 | TONER 11 | CARRIER 7 | B | B | A | A | B | A |
| EXAMPLE 12 | DEVELOPER 18 | TONER 11 | CARRIER 8 | B | B | A | A | B | B |
| EXAMPLE 13 | DEVELOPER 19 | TONER 11 | CARRIER 9 | B | B | A+ | A | B | A |
| EXAMPLE 14 | DEVELOPER 20 | TONER 11 | CARRIER 10 | B | B | A+ | A | B | A |
| EXAMPLE 15 | DEVELOPER 21 | TONER 12 | CARRIER 10 | B | A | A+ | A | A | A |

Aspects of the present invention are, for example, as follows.

According to a first aspect of the present invention, an electrophotographic developer includes a carrier and a pulverized toner. The carrier includes a core material particle and a coating layer coating the core material particle, and has an internal void ratio of 0.0% or more and less than 2.0%. The pulverized toner includes a polyester resin, an aromatic petroleum resin, and a hydrocarbon wax, and an addition amount of the aromatic petroleum resin is 2 parts by mass or more and 15 parts by mass or less with respect to 100 parts by mass of the pulverized toner.

According to a second aspect, in the electrophotographic developer according to the first aspect, the hydrocarbon wax includes a Fischer-Tropsch wax.

According to a third aspect, in the electrophotographic developer according to the first or second aspect, the carrier has an apparent density of 2.4 g/cm³ or more and 2.7 g/cm³ or less.

According to a fourth aspect, in the electrophotographic developer according to any one of the above first to third aspects, the coating layer includes carbon black.

According to a fifth aspect, in the electrophotographic developer according to any one of the above first to fourth aspects, the core material particle comprises Cu—Zn ferrite.

According to a sixth aspect, in the electrophotographic developer according to any one of the above first to fifth aspects, the aromatic petroleum resin includes a styrenic resin.

According to a seventh aspect, in the electrophotographic developer according to the sixth aspect, the styrenic resin includes a styrene-α-methylstyrene copolymer.

According to an eighth aspect, an electrophotographic image forming method includes forming an electrostatic latent image on an electrostatic latent image bearer, developing the electrostatic latent image with the electrophotographic developer according to any one of the above first to seventh aspects to form a toner image, transferring the toner image onto a recording medium, and fixing the transferred toner image on the recording medium.

According to a ninth aspect, an electrophotographic image forming apparatus includes an electrostatic latent image bearer, an electrostatic latent image forming device to form an electrostatic latent image on the electrostatic latent image bearer, and a developing device including the electrophotographic developer according to any one of the above first to seventh aspects to develop the electrostatic latent image formed on the electrostatic latent image bearer to form a toner image.

According to a tenth aspect, a process cartridge includes the electrophotographic developer according to any one of the above first to seventh aspects.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An electrophotographic developer comprising:
a carrier including a core material particle and a coating layer coating the core material particle, the carrier having an internal void ratio of 0.0% or more and less than 2.0%; and
a pulverized toner including a polyester resin, an aromatic petroleum resin, and a hydrocarbon wax, an addition amount of the aromatic petroleum resin being 2 parts by mass or more and 15 parts by mass or less with respect to 100 parts by mass of the pulverized toner.

2. The electrophotographic developer according to claim 1, wherein the hydrocarbon wax includes a Fischer-Tropsch wax.

3. The electrophotographic developer according to claim 1, wherein the carrier has an apparent density of 2.4 g/cm³ or more and 2.7 g/cm³ or less.

4. The electrophotographic developer according to claim 1, wherein the coating layer includes carbon black.

5. The electrophotographic developer according to claim 1, wherein the core material particle comprises Cu—Zn ferrite.

6. The electrophotographic developer according to claim 1, wherein the aromatic petroleum resin includes a styrenic resin.

7. The electrophotographic developer according to claim 6, wherein the styrenic resin includes a styrene-α-methylstyrene copolymer.

8. An electrophotographic image forming method comprising:
forming an electrostatic latent image on an electrostatic latent image bearer;
developing the electrostatic latent image with the electrophotographic developer according to claim 1 to form a toner image;
transferring the toner image onto a recording medium; and
fixing the transferred toner image on the recording medium.

9. An electrophotographic image forming apparatus comprising:
an electrostatic latent image bearer;
an electrostatic latent image forming device to form an electrostatic latent image on the electrostatic latent image bearer; and
a developing device including the electrophotographic developer according to claim 1 to develop the electrostatic latent image formed on the electrostatic latent image bearer to form a toner image.

10. A process cartridge comprising:
an electrostatic latent image bearer; and
a developing device including the electrophotographic developer according to claim 1.
